(19) United States
(12) Patent Application Publication
(10) Pub. No.: US 2015/0207255 A1
(43) Pub. Date: Jul. 23, 2015

(54) FEMALE TERMINAL

(71) Applicant: YAZAKI CORPORATION, Tokyo (JP)

(72) Inventors: Daisuke SUGIYAMA, Kakegawa-shi (JP); Tsutomu SAWADA, Kakegawa-shi (JP); Takashi TSUKAMOTO, Kakegawa-shi (JP)

(73) Assignee: YAZAKI CORPORATION, Tokyo (JP)

(21) Appl. No.: 14/672,388

(22) Filed: Mar. 30, 2015

Related U.S. Application Data
(63) Continuation of application No. PCT/JP2013/076776, filed on Oct. 2, 2013.

(30) Foreign Application Priority Data
Oct. 2, 2012 (JP) 2012-220148

(51) Int. Cl. H01R 13/11

(52) U.S. Cl. CPC H01R 13/11

(57) ABSTRACT

A female terminal includes a terminal connecting part into which a male terminal can be inserted. The terminal connecting part includes: a oscillating fulcrum part; a pressure-receiving part which is disposed at one side of the terminal connecting part in relation to the oscillating fulcrum part, and which is pressed by the male terminal during the process of inserting the male terminal; and a contact part which is disposed at the other side of the terminal connecting part in relation to the oscillating fulcrum part, is positioned at a non-touching position separate from the male terminal; and changes position to a touching position touching the male terminal by an oscillation of the oscillating fulcrum part.

### CROSS REFERENCE TO RELATED APPLICATIONS

This application is a continuation of International Application No. PCT/JP2013/076776, filed Oct. 2, 2013, and based upon and claims the benefit of priority from Japanese Patent Application No. 2012-220148, filed Oct. 2, 2012, the entire contents of all of which are incorporated herein by reference.

### TECHNICAL FIELD

The present application relates to a female terminal.

### BACKGROUND

For a conventional female terminal, for example, there is one illustrated in FIGS. 1A to 1C (refer to JP H10-116644 A). As illustrated in FIGS. 1A to 1C, a conventional female terminal 50 includes a cylindrical terminal connecting part 51 into which a male terminal (not illustrated) is inserted. The terminal connecting part 51 is partitioned into four partitioned cylindrical parts 53 by slits 52. In a position close to a leading end of each partitioned cylindrical part 53, a contact part 54 is formed so as to project from an inner face of each cylindrical part 53.

The male terminal (not illustrated) is inserted into the terminal connection part 51 of the female terminal 50 during the engagement process between connectors. Then, by pressure through the male terminal, respective partitioned cylindrical parts 53 deform elastically in a direction to increase a terminal's diameter, so that the insertion of the male terminal is permitted. The male terminal is inserted to an insertion completion position while sliding on the contact parts 54 of respective partitioned cylindrical parts 53. In the insertion completion position, the male terminal comes into contact with respective contact parts 54 of the female terminal 50 by elastic restoring force.

### SUMMARY

In the conventional female terminal 50, during the insertion process of the male terminal (not illustrated), however, as the male terminal slides on the contact parts 54 from a point of time when the male terminal comes in touch with the contact parts 54 of the female terminal 50 up to a point of time when the male terminal reaches the insertion completion position, the sliding stroke is long and the sliding wear is large. In the female terminal 50, especially, its wear is large in comparison with that of the male terminal since only the contact parts 54 slide on the male terminal. In this way, large sliding wear causes low durability of the terminal. Consequently, it is necessary to increase a plating thickness to improve the durability of the terminal related to the sliding wear, causing a price increasing of the terminal.

Under such a situation, an object of the present application is to provide a female terminal which is capable of reducing sliding wear of the terminal and also realizing cost reductions.

A female terminal according to a first aspect of the present application includes a terminal connecting part into which a male terminal can be inserted. The terminal connecting part includes an oscillating fulcrum part, a pressure-receiving part disposed at one side of the terminal connecting part in relation to oscillating fulcrum part and pressed by the male terminal during the process of inserting the male terminal, and a contact part disposed at the other side of the terminal connecting part in relation to the oscillating fulcrum part and positioned at a non-touching position separate from the male terminal, the contact part being capable of changing a position thereof from the non-touching position to a touching position allowing the contact part to touch the male terminal by an oscillation of the oscillating fulcrum part.

The pressure-receiving part may have an inclined profile so as to enter an insertion area of the male terminal as going toward an insertion direction of the male terminal.

The pressure-receiving part may have a projecting profile so as to project into an insertion area of the male terminal perpendicularly.

With the female terminal according to the first aspect of the present application, since, during the process of inserting the male terminal into the terminal connecting part, at least the female terminal does not slide on the contact part of the female terminal till the male terminal presses the pressure-receiving part of the female terminal so that the contact part moves to the touching position, the sliding stroke of the male terminal is shortened by just that much. Consequently, it is possible to reduce sliding wear of the terminals and also reduce manufacturing costs.

### BRIEF DESCRIPTION OF DRAWINGS

FIG. 1A is a front view of a conventional female terminal, FIG. 1B is a sectional view taken along a line X-X of FIG. 1A, and FIG. 1C is an enlarged view of an essential part of FIG. 1B.

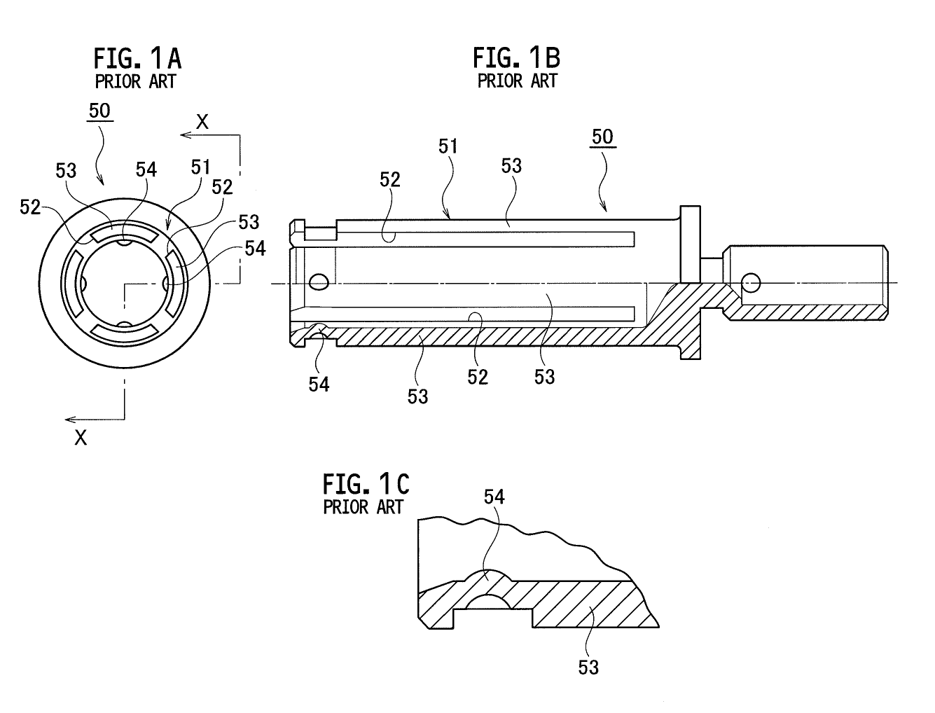

FIG. 2A is a sectional view of a female connector and a male connector according to a first embodiment, in a condition before their engagement, and FIG. 2B is a plan view of a substantial part of a terminal connecting part of the female terminal according to the first embodiment.

FIGS. 3A to 3C are respective sectional views illustrating the engagement process between the female connector and the male connector according to the first embodiment.

FIG. 4A is a sectional view of a female connector and a male connector according to a second embodiment, and FIG. 4B is a plan view of a substantial part of a terminal connecting part of the female terminal according to the second embodiment.

FIGS. 5A to 5C are respective sectional views illustrating the engagement process between the female connector and the male connector according to the second embodiment.

### DESCRIPTION OF EMBODIMENTS

Embodiments will be described with reference to drawings, below.

### First Embodiment

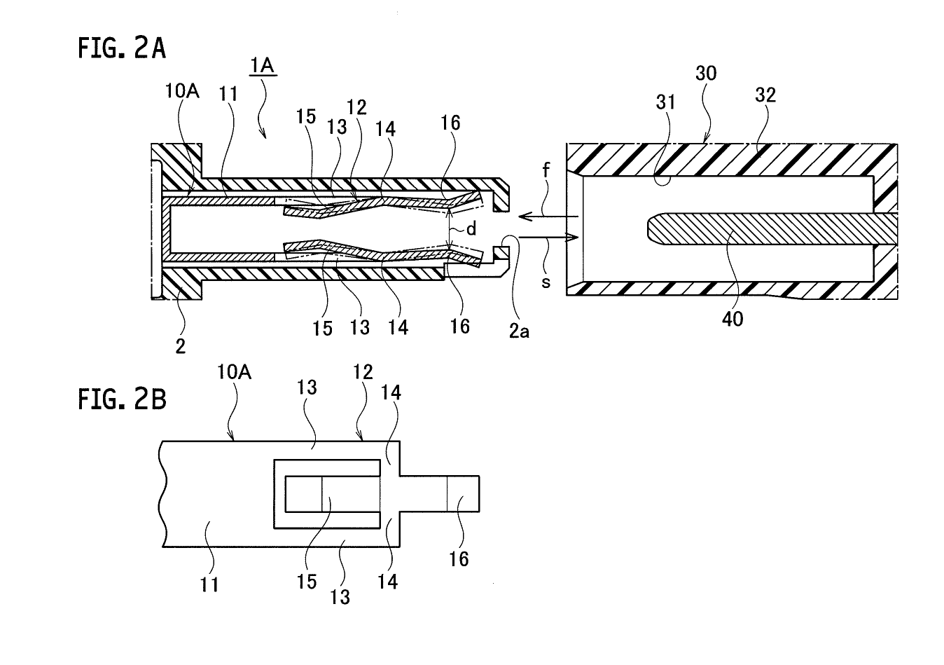

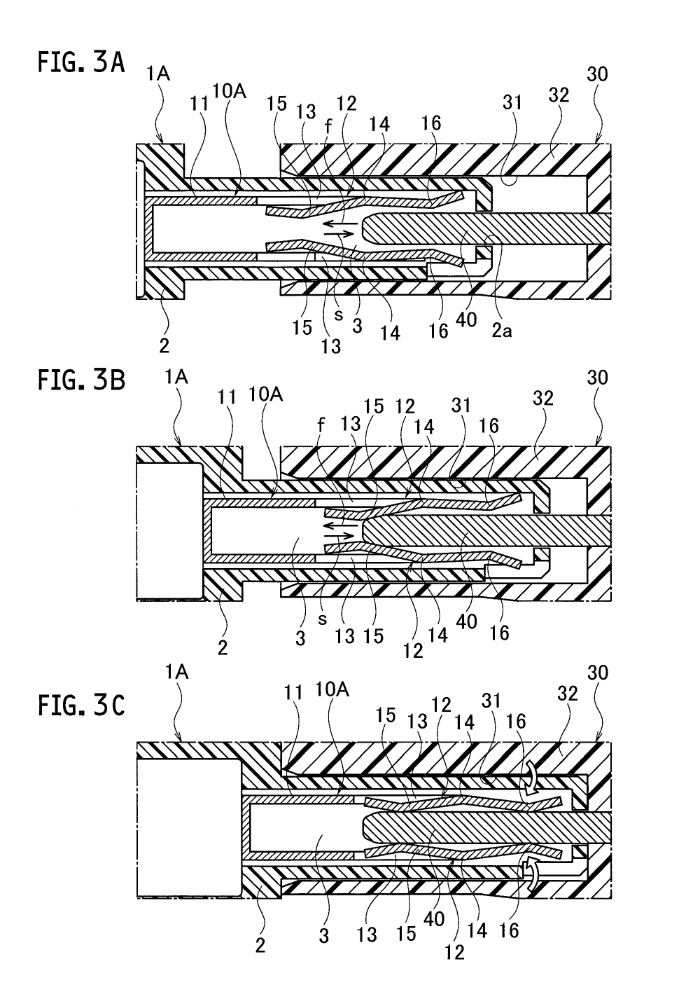

FIGS. 2A, 2B, and 3A to 3C illustrate a first embodiment. For instance, a first connector 1 A according to the first embodiment is applied to a charge connector on the side of a charging apparatus, such as a charging station, while a second connector 30 is applied to a charge inlet apparatus on the side of a vehicle to be supplied with electricity through the charge connector.

As illustrated in FIG. 2A and 2B, the first connector 1A according to the first embodiment includes a male connector housing 2 having a terminal housing 3, and a female terminal 10A housed in the terminal housing 3.

A terminal insertion slot 2a opens on the side of one end of the terminal housing 3. The male terminal 40 is inserted through the terminal insertion slot 2a.

The female terminal 10A is housed in the terminal housing 3 under condition that the positioning is established in its insertion/withdrawal directions. The female terminal 10A is made from a conductive member. The female terminal 10A includes a base part 11, and a pair of terminal connecting parts 12 whose base end sides are supported by the base part 11. The pair of terminal connecting parts 12 are arranged separate from each other at an interval. Each of the terminal connecting parts 12 includes a fixing support part 13, a pair of oscillating fulcrum parts 14 swingably supported on the fixing support part 13, a pressure-receiving part 15 disposed at one side in relation to the pair of the oscillating fulcrum parts 14 and on the downstream side in the insertion direction f of the male terminal 40, and a contact part 16 disposed at the other side in relation to the pair of the oscillating fulcrum parts 14 and on the upstream side in the insertion direction f of the male terminal. The pressure-receiving part 15 and the contact part 16 are displaced between a position illustrated with a solid line of FIG. 2A and a position illustrated with an imaginary line of FIG. 2A about the pair of oscillating fulcrum parts 14 as oscillation fulcra.

The pressure-receiving part 15 is established in a position where it is pressed by the male terminal 40 in the second-half stroke of the insertion process of the male terminal 40. The pair of pressure-receiving parts 15 have tapered shapes inclined so as to narrow an interval therebetween as going toward the insertion direction f of the male terminal 40. The tip side behind each of the tapered shapes is positioned in an insertion area of the male terminal 40.

Each of the contact parts 16 is positioned at a non-touching position separate (i.e. a position illustrated with the solid line of FIG. 2A) from the male terminal 40 and also formed so as to change its position to a touching position (i.e. a position illustrated with the imaginary line of FIG. 2A) in contact with the male terminal 40. The narrowest interval d between the pair of contact parts 16 is set to be somewhat larger the width dimension of the male terminal 40 under no-load condition with no external force, so that the contact parts 16 are positioned at the non-touching positions separated from the male terminal 40, respectively. Owing to the oscillation of the pair of oscillating fulcrum parts 14, the pair of contact parts 16 can change their positions to the touching positions in touch with the male connector 40.

The second connector 30 as a mating connector includes a female connector housing 32 having a connector fitting chamber 31, and the male terminal 40 fixed in the female connector housing 32 to project into the connector fitting chamber 31.

Next, the engagement operation between the first connector 1A and the second connector 30 will be described. It is performed to insert the male connector housing 2 of the first connector 1A into the connector fitting chamber 31 of the second connector 30. Then, as illustrated in FIG. 3A, the male terminal 40 is inserted between the pair of terminal connecting parts 12 of the female terminal 10A through the terminal insertion slot 2a of the male connector housing 2. With progress of the insertion of the male terminal 40, as illustrated in FIG. 3B, the tip of the male terminal 40 comes in touch with the tapering parts 15 of the female terminal 10A. With further progress of the insertion of the male terminal 40, the pressing power of the male terminal 40 acts on the pressure-receiving parts 15 to cause the upper and lower oscillating fulcrum parts 14 to be deformed torsionally, so that the pair of contact parts 16 are displaced in respective directions to narrow the interval therebetween (i.e. moving toward the touching position). Then, as illustrated in FIG. 3C, when the male terminal 40 reaches a position just before the insertion completion position or occupies the insertion completion position, the pair of contact parts 16 are moved to the touching positions, so that the pair of contact parts 16 come in touch with the male terminal 40 initially. Thus, at the insertion completion position, there is realized a condition that the pair of contact parts 16 of the female terminal 10A touch the male terminal 40.

When separating the first connector 1A and the second connector 30 under their engagement condition from each other, the male terminal 40 moves inside the pair of the terminal connecting parts 12 in the withdrawal direction s. During this moving process, the tip of the male terminal 40 slip off the pair of pressure-receiving parts 15. Consequently, the upper and lower oscillating fulcrum parts 14 is returned from the torsional deformation and the pair of contact parts 16 are returned to their non-touching positions. Subsequently, the male terminal 40 moves in the withdrawal direction s without sliding on the terminal connecting parts 12 of the female terminal 10A, so that the engagement between the connectors is cancelled.

In the process of inserting the male terminal 40 into the terminal connecting parts 12, as mentioned above, at least the female terminal 40 does not slide on the contact parts 16 of the female terminal 10A till the male terminal 40 presses the tapering parts 15 of the female terminal 10A so that the contact parts 16 move to the touching positions. For this reason, the sliding stroke of the male terminal is shortened by just that much, so that it is possible to reduce sliding wear of the male terminal 40 and the female terminal 10A. Moreover, also in the process of separating the male terminal 40 from the inside of the terminal connecting parts 12, the sliding stroke is shortened due to the operation substantially opposite to that mentioned above, so that the sliding wear of the male terminal 40 and the female terminal 10 can be reduced. From above, there is no need of increasing the thickness of plating in view of improving the durability of male terminal 40 and the female terminal 10A, which results in cost reduction.

The pressure-receiving parts 15 are set at respective positions where they are pressed by the male terminal 40 in the latter half stroke during the insertion process of the male terminal 40. When the male terminal 40 reaches a position just before the insertion completion position or occupies the insertion completion position, the pair of contact parts 16 are moved to the touching positions where they come in touch with the male terminal 40 initially. Thus, as the sliding stroke between the male terminal 40 and the contact parts 17 of the female terminal 10A shortens remarkably, it is possible to reduce the sliding wear of the male terminal 40 and the female terminal 10A to the utmost.

The pressure-receiving parts 15 have inclined profiles so as to enter the insertion area of the male terminal 40 as going toward the insertion direction f of the male terminal 40. Therefore, as the pressure-receiving parts 15 are subjected to pressing power which is gradually increased in the process of inserting the male terminal 40, the pair of oscillating fulcrum parts 14 are torsionally-deformed smoothly.

### Second Embodiment

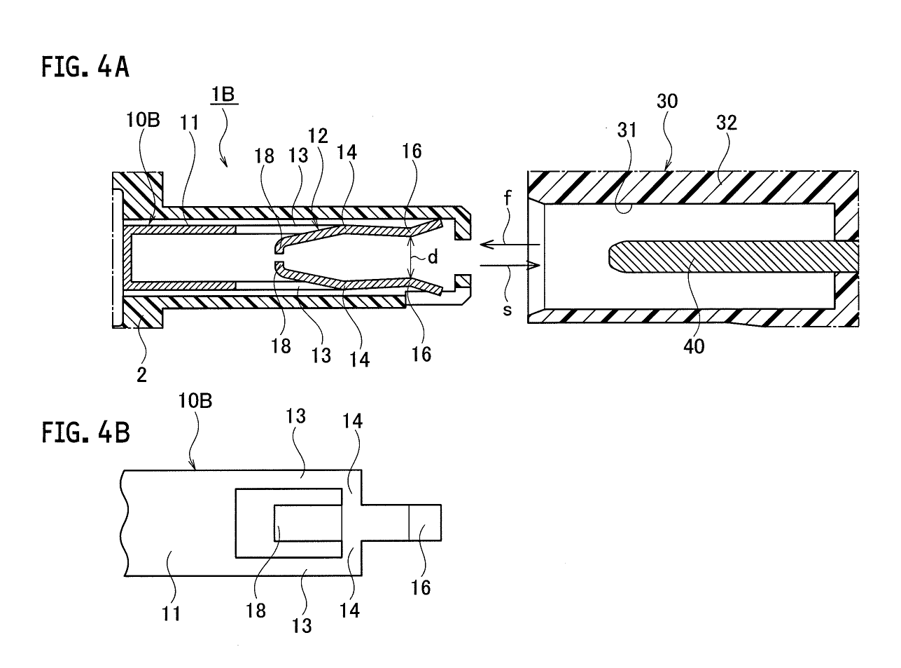

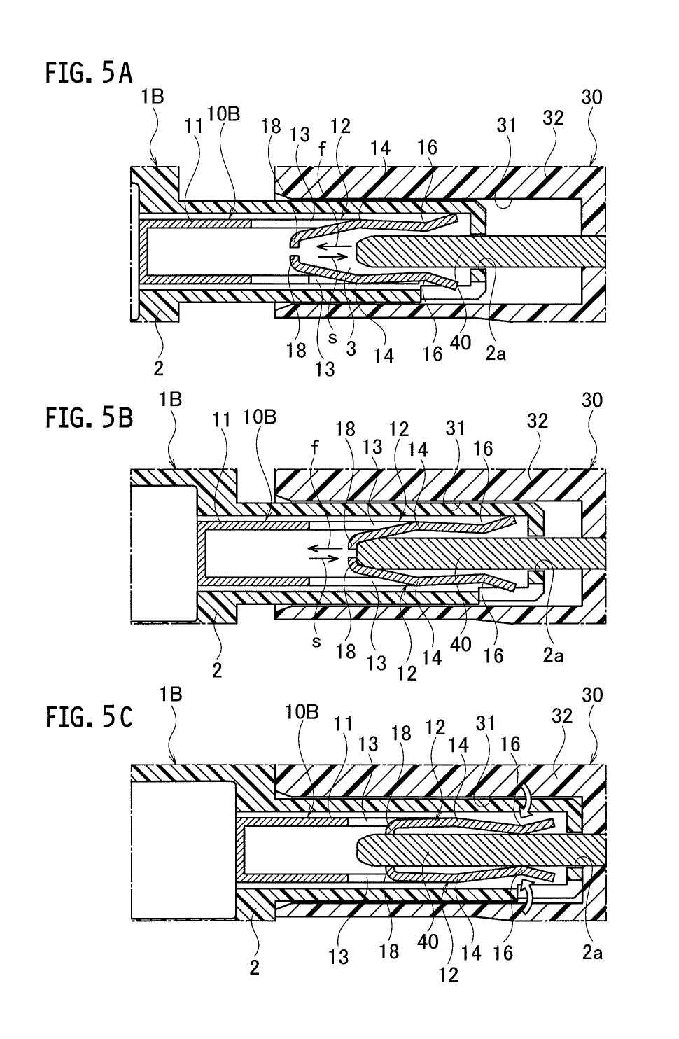

FIGS. 4A, 4B, and 5A to 5C illustrate a second embodiment. A first connector 1B according to the second embodiment differs from the first connector 1A according to the first embodiment in the constitution of pressure-receiving parts 18 of a female terminal 10B. The pressure-receiving parts 18 are shaped so that their backward tips project into the insertion area of the male terminal 40 perpendicularly.

As the other constitution of the second embodiment is similar to that of the first embodiment, elements identical to those of the first embodiment will be indicated with the same reference numerals in the figures and their overlapping descriptions are omitted.

Next, the engagement operation between the first connector 1B according to the second embodiment and the second connector 30 will be described. It is performed to insert the male connector housing 2 of the first connector 1B into the connector fitting chamber 31 of the second connector 30. Then, as illustrated in FIG. 5A, the male terminal 40 is inserted between the pair of terminal connecting parts 12 of the female terminal 10B through the terminal insertion slot 2a of the male connector housing 2. With progress of the insertion of the male terminal 40, as illustrated in FIG. 5B, the tip of the male terminal 40 comes in touch with the pressure-receiving parts 18 of the female terminal 10B. With further progress of the insertion of the male terminal 40, the pressing power of the male terminal 40 acts on the pressure-receiving parts 18 to cause the upper and lower oscillating fulcrum parts 14 to be deformed torsionally, so that the pair of contact parts 16 are displaced in respective directions to narrow the interval therebetween (i.e. moving toward the touching position). Then, as illustrated in FIG. 5C, when the male terminal 40 reaches a position just before the insertion completion position or occupies the insertion completion position, the pair of contact parts 16 are moved to the touching positions, so that the pair of contact parts 16 come in touch with the male terminal 40 initially. Thus, at the insertion completion position, there is realized a condition that the pair of contact parts 16 of the female terminal 10B touch the male terminal 40.

When separating the first connector 1B and the second connector 30 under their engagement condition from each other, the male terminal 40 moves inside the pair of the terminal connecting parts 12 in the withdrawal direction s. During this moving process, the tip of the female terminal 10B slip off the pair of pressure-receiving parts 18. Consequently, the upper and lower oscillating fulcrum parts 14 is returned from the torsional deformation and the pair of contact parts 16 are returned to their non-touching positions. Subsequently, the male terminal 40 moves in the withdrawal direction s without sliding on the terminal connecting parts 12 of the female terminal 10B, so that the engagement between the connectors is cancelled.

Also in the second embodiment, as similar to the first embodiment, at least the female terminal 40 does not slide on the contact parts 16 of the female terminal 10B till the male terminal 40 presses the pressure-receiving parts 18 of the female terminal 10B so that the contact parts 16 move to the touching positions. For this reason, the sliding stroke of the male terminal 40 is shortened by just that much, so that it is possible to reduce sliding wear of the male terminal 40 and the female terminal 10B. Moreover, also in the process of separating the male terminal 40 from the inside of the terminal connecting parts 12, the sliding stroke is shortened due to the operation substantially opposite to that mentioned above, so that the sliding wear of the male terminal 40 and the female terminal 10B can be reduced. From above, there is no need of increasing the thickness of plating in view of improving the durability of male terminal 40 and the female terminal 10B, which results in cost reduction.

The pressure-receiving parts 18 are shaped so as to project into the insertion area of the male terminal 40 perpendicularly. Thus, as the contact parts 16 can be moved to the touching positions with short stroke of the male terminal 40 during the insertion process, it is possible to shorten the sliding section between the male terminal 40 and the female terminal 10B as much as possible.

What is claimed is:

1. A female terminal, comprising:
a pair of terminal connecting parts facing each other, into which a male terminal can be inserted,
the terminal connecting parts each comprising:
an oscillating fulcrum part;
a pressure-receiving part disposed at one side of the terminal connecting part in relation to oscillating fulcrum part and pressed by the male terminal during the process of inserting the male terminal; and
a contact part disposed at the other side of the terminal connecting part in relation to the oscillating fulcrum part and positioned at a non-touching position separate from the male terminal, the contact part being capable of changing a position thereof from the non-touching position to a touching position allowing the contact part to touch the male terminal by an oscillation of the oscillating fulcrum part.

2. The female terminal of claim 1, wherein
the pressure-receiving part has an inclined profile so as to enter an insertion area of the male terminal as going toward an insertion direction of the male terminal.

3. The female terminal of claim 1, wherein
the pressure-receiving part has a projecting profile so as to project into an insertion area of the male terminal perpendicularly.
